(19) United States
(12) Patent Application Publication
(10) Pub. No.: US 2024/0174353 A1
(43) Pub. Date: May 30, 2024

(54) VERTICAL TAKE-OFF AND LANDING AIRCRAFT BASED ON VARIABLE ROTOR-WING TECHNOLOGY AND DUAL ROTOR-WING LAYOUT

(71) Applicant: Lei Xiong, Nanchang (CN)

(72) Inventor: Lei Xiong, Nanchang (CN)

(21) Appl. No.: 18/432,094

(22) Filed: Feb. 5, 2024

Related U.S. Application Data
(63) Continuation of application No. PCT/CN2022/109320, filed on Jul. 31, 2022.

(30) Foreign Application Priority Data
Sep. 28, 2021 (CN) 202111143178.8

(51) Int. Cl. B64C 27/26; B64C 1/00; B64C 3/40; B64D 27/02

(52) U.S. Cl. CPC B64C 27/26; B64C 1/0009; B64C 3/40; B64D 27/02

(57) ABSTRACT

The application discloses a vertical take-off and landing aircraft based on variable rotor-wing technology and dual rotor-wing layout. A main aerodynamic surface adopts the design of dual blade variable rotor-wings, and may be switched between a rotor wing and a fixed wing configuration along with variation of flight speed; based on variable rotor-wing technology and dual rotor-wing layout, power requirements for a power system are greatly reduced while vertical take-off and landing and high-speed level flight are realized; meanwhile, through coordinated linkage with the fuselage and actuating mechanism devices, better flight efficiency and maneuverability are obtained in the entire flight envelope. The aircraft has good hover and low-speed performance, but has certain requirements for apron parking facilities, so it is more suitable for use in fixed sites with limited space or carried on low-speed vehicles to complete various aviation tasks such as atmospheric detection.

### CROSS-REFERENCE TO RELATED APPLICATIONS

The present disclosure is a continuation of International Application No. PCT/CN2022/109320, filed on Jul. 31, 2022, which claims priority to Chinese Patent Application No. 202111143178.8, filed on Sep. 28, 2021. All of the aforementioned applications are incorporated herein by reference in their entireties.

### TECHNICAL FIELD

The present disclosure belongs to the technical field of aviation aircraft design, and relates to a vertical take-off and landing aircraft based on variable rotor-wing technology and dual rotor-wing layout.

### BACKGROUND

An airplane is a general name of aircrafts which are heavier than air and may stably maintain in the air by means of self power, which has extremely profound influence on the world although it is only over one hundred years since its birth. The airplane may not only carry various loads or quickly transport to different places thousands of miles away or climb to a high altitude to complete various tasks such as atmospheric exploration, ground exploration, relay communication and the like, but also easily overcome various harsh terrains such as mountains, canyons, oceans, gobi and the like, and may safely take off and land under limited or even dangerous environments, which has become an important industrial vehicle and a landmark invention in the contemporary society. However, it is difficult to integrate all advantages mentioned above on one or a single type of aircraft: fast transportation and long endurance are the specialties of fixed wing airplanes, which, however, have strict requirements on take-off and landing facilities such as runway field length, peripheral building limit height and the like, causing poor use flexibility; ignoring topographic and environmental factors to complete take-off and landing is the advantage of rotor wing airplanes, which, however, have low cruising and level flight efficiency, and further, key performance indexes such as maximum range, speed and altitude are limited. Fueled by the explosive development of science and technology, the current design requirements of rotor wing airplanes and fixed wing airplanes have been significantly differentiated, and both the advantages and disadvantages of performances are highly complementary; the integration of the advantages of the two will undoubtedly greatly enhance the use value of the aircraft, which, however, also needs to cross a huge technical gap.

After a long period of technology accumulation and uninterrupted attempts, the current vertical take-off and landing fixed-wing configuration has achieved the above goals to a certain extent. This configuration is developed based on the fixed wing airplanes as the name implies, which retains the advantages of the latter in the aspects of range, speed, altitude and cruising efficiency to the maximum extent, and realizes the vertical take-off and landing capability similar to that of the rotor wing airplanes through the following three solutions: 1. power deflection, a power vector pointing forward in level flight is deflected into a vertical upward power vector in the take-off and landing state so as to overcome gravity; 2. power lifting, high-energy airflow generated by a power system acts on the wing surface to generate a large amount of additional high lift circulation; and 3. power compounded, multiple sub power units are independently designed for take-off and landing and cruising state, and corresponding power unit is switched in different flight states to maximize the current efficiency. All of the above three solutions require a large amount of power extracted from the power system to generate lift, and therefore have significant disadvantages: the level flight aerodynamic drag of the fixed wing airplane is far smaller than its self-weight, so that the power deflection solution needs to balance both the take-off and landing performance and the level flight performance, which decreases the efficiency of the entire airplane; the power lifting solution has the disadvantages that the additional high lift circulation can easily causes airflow separation and local stall on the aerodynamic surfaces, resulting in a steep drop or even instability of the aerodynamic characteristics of the entire aircraft, and thus this solution is mainly used for realizing short-distance take-off and landing; the power compounded solution inherits the physical principle limitation of each sub power unit while obtaining the advantage of high redundancy, and thus only obtaining higher efficiency in a specific use range. It can be considered that the vertical take-off and landing fixed-wing configuration only partially takes into account the flight characteristics of the rotor wing airplanes and the fixed wing airplanes, and does not effectively integrate the performance advantages of the two.

Aiming at the problems encountered in the vertical take-off and landing fixed-wing configuration, engineers developed a new approach in late 20th century, trying to switch the configuration of the main aerodynamic surface of the aircraft, so that it might not only quickly rotate around its vertical central axis during take-off and landing and low-speed forward flight, but also be fixed in high-speed airflow with a suitable shape during medium-high speed flight. In the end, the performance advantages of the rotor wing and the fixed wing are successfully integrated, and this unique aerodynamic wing surface is also therefore referred to as a rotor-wing. Sikorsky S-72X1 and Boeing X-50A have made pioneering attempts on this concept. S-72X1 adopts a traditional helicopter configuration, a rotor-wing located above the middle of a fuselage is composed of four rigid wing blades, leading-trailing ends symmetrical wing section shape is adopted, active flow control devices based on the Coanda effect are installed at both the leading and trailing edges of the wing surfaces, and during rotating or fixing in the X-plane shape, airflow is generated by the active flow control devices to actively control the local wing section circulation, so as to synchronously adjust the collective pitch and cyclic pitch of the rotor-wing in rotating and the lift coefficient in fixing. X-50A adopts a three-wing-surface layout with higher redundancy in the fixed wing airplane, and a medium aspect ratio dual blade rotor-wing with the similar leading-trailing ends symmetrical wing section shape design may be switched between the configuration of rotor wing and fixed wing, and exhaust flow of a turbofan engine arranged in a fuselage may be diverted to nozzles mounted at the tip of the main wing or the rear portion of the fuselage to respectively provide thrust for rotation of the rotor wing or level flight of the entire airplane.

The rotor-wing may generate lift efficiently in both configurations of rotor wing and fixed wing, which not only provides better aerodynamic efficiency for the aircraft in hover and high-speed level flight, but also greatly reduces the maximum power requirement for the above two configurations and optimizes the design of the power system; reasonable aerodynamic layout may also provide perfect stability and maneuverability for the flight under the configurations of rotor wing and fixed wing. However, this design also has obvious disadvantages: when wing blades on retreating side of the rotor-wing are rotated or fixed, the airflow directions are completely opposite, so the leading-trailing ends symmetrical wing section shape needs to be adopted, which weakens the key aerodynamic characteristics such as the maximum lift coefficient and lift to drag ratio; in addition, the aircraft needs to complete configuration switching at a certain forward flight speed; in such a case, due to the drastic variations in the rotation speed of the rotor-wing, it is still difficult to generate stable lift even if complex active flow control and collective pitch variation are adopted, and even complete unloading is required to prevent the interference of asymmetric moment on the flight attitude of the entire airplane, therefore, auxiliary wing surfaces are needed to generate alternative lift, which also increases the risk and difficulty of this transition flight state. These technical shortcomings further limit the development of this new concept of aircraft with great potential.

### SUMMARY

In order to overcome the defects of the traditional fixed-wing vertical take-off and landing aircraft and single rotor-wing aircraft, the present disclosure provides a design solution of a vertical take-off and landing aircraft based on variable rotor-wing technology and dual rotor-wing layout. The main wing surface may be switched between two configurations including rotor wing and fixed wing along with variation of flying speed, the requirements on take-off and landing facilities are greatly reduced through hover in the air and vertical take-off and landing capabilities of the former, based upon this, high-altitude and high-speed level flight capabilities of the latter are considered; meanwhile, the cruising efficiency of the aircraft is optimized by reducing the power requirements on a power system under the two configurations. The variable rotor-wing technology and dual rotor-wing layout further optimize the aircraft flight efficiency and maneuverability in the entire flight envelope on the basis of the single rotor-wing concept; when the configuration of the rotor-wing is switching, a main fuselage is in coordinated linkage with each actuating mechanism device, and the risk and difficulty in the flight state are also reduced. The present disclosure effectively integrates the performance advantages of both rotor wing airplane and fixed wing airplane, and improves the efficiency of the aircraft in the aspects of power, control, maneuverability and the like and the robustness in transition flight state, thus adapting to various complex usage scenarios s and obtain better overall operation and use efficiency.

The aircraft is composed of dual blade variable rotor-wings, a dual rotor-wing system, a lifting fuselage, a wing-fuselage connecting mechanism, a forward flying propulsion device and a central power system, and is provided with a take-off and landing auxiliary device; the detailed definitions of the respective components are described later.

The working state of the main aerodynamic wing surfaces of the aircraft may be divided into a rotor wing configuration and a fixed wing configuration, and a transition flight state connecting the two. The aircraft may hover or fly forwards at low speed in the rotor wing configuration, and the main aerodynamic wing surfaces generate all lift by rapidly rotating around their vertical central axes. The aircraft will operate at medium-high speed in the fixed wing configuration, and the main aerodynamic wing surfaces are rigidly connected with the lifting fuselage and generate all lift together with the latter. The speed range of the transition flight state is between that of the two above configurations, which is operated at a low altitude with higher atmospheric density, and all lift is generated by virtue of the lifting fuselage.

The dual blade variable rotor-wings: the dual blade variable rotor-wings are wing surfaces with variable configurations capable of not only rotating rapidly around their vertical central axes on the rotor wing principle but also rigidly connecting to the lifting fuselage on the fixed wing principle. The purpose of the wing surfaces with variable configurations is to adapt to airflow characteristics of the aircraft at different speeds; in the static atmosphere or at low-speed flight, the dual blade variable rotor-wings work on the rotor wing principle, and the wing surfaces rotating at a high speed may not only effectively avoid stall, but also obtain higher aerodynamic and control efficiency; at medium-high speed flight, the dual blade variable rotor-wings work on the fixed wing principle, which avoids the drag increment caused by compressibility effects of the advancing wing blades and unfavorable vortex interference caused by rotation of the wing surfaces, and more excellent aerodynamic characteristics such as maximum speed, altitude, lift to drag ratio and the like are obtained. The dual blade rotor-wing is an ideal design choice by integrating factors such as aerodynamic efficiency, structural stress, arrangement of an actuating mechanism device and the like. On the basis of the dual blade rotor-wing, a variable sweep angle device capable of independently adjusting sweep angles is arranged at the connection between each wing blade and a rotor hub, then the dual blade variable rotor-wing is formed; the wing blades are kept to be unfolded in a straight line shape at two sides of the rotor hub in the rotor wing configuration, and the two wing blades are adjusted to be in a front-rear tandem form in the fixed wing configuration. In two configurations, each wing blade may keep its leading edge facing the incoming airflow, so the traditional leading-trailing ends asymmetric wing section shape may be adopted to improve the aerodynamic efficiency of the dual blade variable rotor-wing in the entire flight envelope. Each dual blade variable rotor-wing is further provided with a wing blade collective pitch adjusting device on the outer side of a variable sweep angle device, which is used for controlling the lift of each group of dual blade variable rotor-wing in the rotor wing configuration, and the pitching, rolling and yawing moment of the entire aircraft in the fixed wing configuration. When the dual blade variable rotor-wing is in the rotor wing configuration, each group of dual blade variable rotor-wing carries out cyclic pitch variation by adopting the teetering rotor hub, so as to balance the asymmetrical aerodynamic force of advancing and retreating wing blades in forward flight.

The dual rotor-wing system: the dual rotor-wing system is to arrange dual groups of dual blade variable rotor-wings which are independent of each other and operate in a mirror-symmetry mode on the airframe. When the dual blade variable rotor-wings are in the rotor wing configuration, dual groups of dual blade variable rotor-wings will rotate against each other to offset the reverse torque to the lifting fuselage; when the dual blade variable rotor-wings are in the fixed wing configuration, the dual blade variable rotor-wings are in mirror symmetry relative to the symmetry plane of the lifting fuselage, two wing blades of each group of dual blade variable rotor-wing are adjusted to the front-rear tandem layout through the variable sweep angle device, and longitudinal and lateral stability as well as pitching, rolling and yawing maneuvering capability are provided for the entire aircraft. The dual rotor-wing system brings a natural symmetry to the overall aerodynamic layout, improving forward flight efficiency and maneuverability in almost all speed ranges.

The lifting fuselage: the lifting fuselage refers to a main fuselage with flying wing shape, similar to a flying wing with small aspect ratio. When the aircraft is in the fixed wing configuration and transition flight state, the lifting fuselage is in horizontal state along downstream flow to generate lift, and two fuselage spoilers in lateral symmetry and capable of generating additional lift are arranged on the lower surface, and dual groups of dual blade variable rotor-wings are symmetrically arranged on the left and right ends of the lifting fuselage. When the aircraft is in rotor wing configuration, the lifting fuselage is in vertical state along downstream flow and perpendicular to the rotor disk planes of the rotor-wings, and dual groups of dual blade variable rotor-wings are distributed at the upper and lower ends of the lifting fuselage. The lifting fuselage completes switching between horizontal and vertical state along downstream flow in the transition flight state, and the process may be controlled by differentially opening or closing the fuselage spoiler.

The wing-fuselage connecting mechanism: the wing-fuselage connecting mechanism plays the role of connecting the dual blade variable rotor-wings to the lifting fuselage of the aircraft, and a 90-degree rotating shaft and corresponding actuating devices are provided with the rotating direction opposite to the lifting fuselage rolling direction, and also plays the role of linking with the lifting fuselage to offset the influence of the variation of the rolling angle of the latter on the lift direction of the dual blade variable rotor-wings, so as to maximize the aerodynamic efficiency.

The forward flying propulsion device: an independent forward flying propulsion device is installed at the tail of the lifting fuselage of the aircraft, which not only provides forward flying thrust for the fixed wing configuration and the transition flight state, but also forms a coaxial dual rotor-wing tail-pushing layout with the dual blade variable rotor-wings in the rotor wing configuration to improve the cruising efficiency at low-speed flight. The forward flying propulsion device may adopt two ways including propeller or jet, the former is more suitable for middle-low altitude subsonic flight, the latter is more suitable for high-altitude transonic flight, and the specific choice will depend on the overall design of the aircraft and the form of the main power device.

The central power system: when the dual blade variable rotor-wing is in the rotor wing configuration, the aircraft will reach the maximum power requirement when hovering; when the dual blade variable rotor-wing is in the fixed wing configuration, the aircraft will reach the maximum power requirement at the maximum level flight speed; through the coordination of the overall design parameters of the entire aircraft, the power requirement under the above two certain conditions may be greatly reduced and matched, so that a single power device may be adopted to provide a unified energy source for the aircraft; meanwhile, the energy is distributed to the dual rotor-wing system and the forward flying propulsion device according to the flight state by relying on a transmission device. The two sets of devices jointly form the central power system; the main power device is arranged at the middle-rear region of the lifting fuselage, directly drive the forward flying propulsion device to maximize transmission efficiency, and may be selected in the form of internal combustion engine, battery, or gas turbine according to the different design requirements of the aircraft, of which the first two are more suitable for medium-low altitude subsonic flight, and the third is more suitable for high-altitude transonic flight. Depending on the main power device, the transmission device will drive the dual rotor-wing system and the forward flying propulsion device by adopting mechanical transmission, electric transmission or bleed air correspondingly.

The take-off and landing auxiliary device: when the dual blade variable rotor-wings are in the rotor wing configuration, it is difficult to arrange a landing gear to realize conventional apron parking because of the large swept area generated by rotation of the dual blade variable rotor-wings mounted at the lower end of the lifting fuselage. In order to provide rapid take-off and landing capability and maintain the effective clearance between the lower dual blade variable rotor-wings and the parking apron, auxiliary devices are arranged in a take-off and landing field, and an extended mechanical arm is rigidly connected with a mechanism device in the belly portion of the lifting fuselage to provide stable support for the aircraft.

### BRIEF DESCRIPTION OF THE DRAWINGS

FIG. 1 is a schematic diagram of main components of an aircraft.

FIG. 2 is an overall layout of rotor wing configuration of an aircraft.

FIG. 3 is an overall layout of fixed wing configuration of an aircraft.

FIG. 4 is a diagram of a bottom view in a forward lateral direction in a transition flight state of an aircraft.

FIG. 5 is a schematic procedure diagram before take-off of an aircraft.

FIG. 6 is a schematic procedure diagram after take-off of an aircraft.

FIG. 7 is a schematic diagram of a forward flight of a rotor wing configuration of an aircraft.

FIG. 8 is a schematic procedure diagram when a rotor-wing exits a rotor wing configuration in a transition flight state.

FIG. 9 is a schematic procedure diagram when a rotor-wing switches configuration in a transition flight state.

FIG. 10 is a schematic procedure diagram when a rotor-wing enters a fixed wing configuration in a transition flight state.

### DETAILED DESCRIPTION OF THE EMBODIMENTS

The layout of an aircraft will be further described in detail below with reference to drawings.

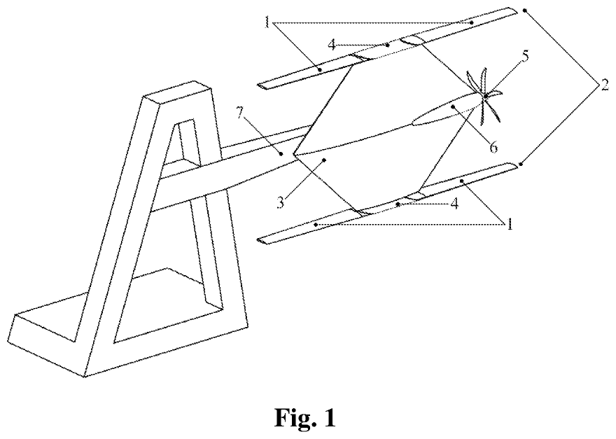

The working state of main aerodynamic wing surfaces of the aircraft may be divided into a rotor wing configuration and a fixed wing configuration, and a transition flight state connecting the two. The aircraft may hover or fly forwards at low speed in the rotor wing configuration, and the main aerodynamic wing surfaces generate all lift by rapidly rotating around their vertical central axes. The aircraft in the fixed wing configuration will operate at medium-high speed, and the main aerodynamic wing surfaces are rigidly connected with the lifting fuselage and generate all lift together with the lifting fuselage. The speed range of the transition flight state is between that of the two above configurations, which is operated at a low altitude with higher atmospheric density. FIG. 1 illustrates main components when the aircraft is in an apron parking status. The dual blade variable rotor-wings 1, a dual rotor-wing system 2, a lifting fuselage 3, a wing-fuselage connecting mechanism 4, a forward flying propulsion device 5 and a central power system 6 form an aircraft main airframe together. Due to special layout of the aircraft, indirect apron parking capability will be provided by a take-off and landing auxiliary device 7.

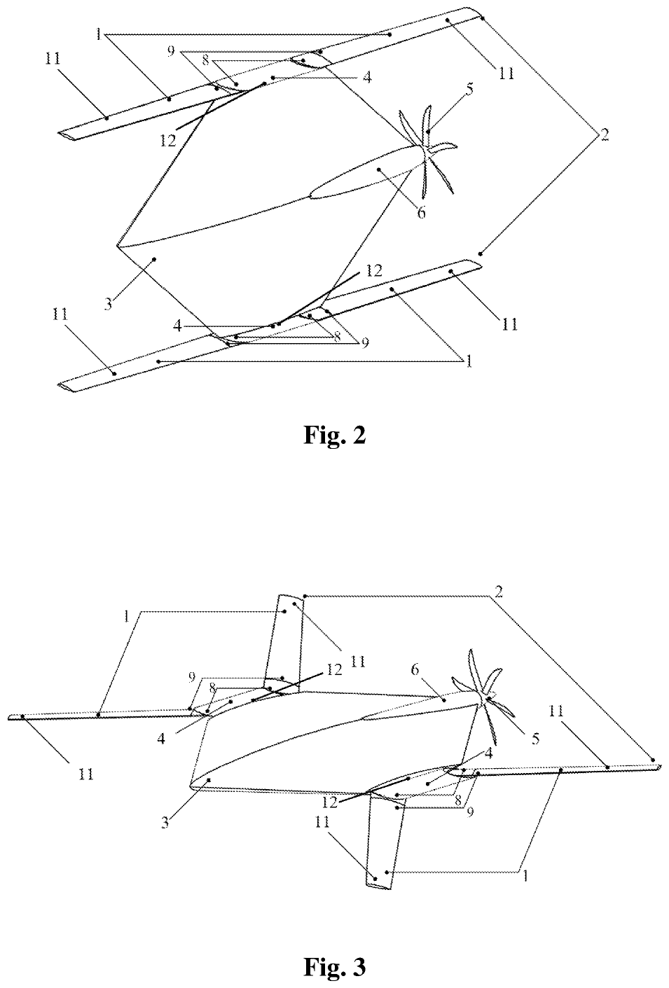

The overall layout of rotor wing configuration of the aircraft is shown in FIG. 2. The lifting fuselage 3 is in vertical state along downstream flow, wing blades 11 of each group of dual blade variable rotor-wings 1 are unfolded in a straight line, and respectively distributed at the upper and lower ends of the lifting fuselage 3 to maximize the space between, so as to prevent geometrical interference. The rotor disk planes of upper and lower rotor-wings are horizontal but the rotation directions are opposite, rotating shafts are mutually overlapped and pass through the centre of gravity of the entire aircraft, thus forming a typical coaxial dual rotor-wing layout, while the reverse torque is completely eliminated, the flight maneuver in a small range is realized through a wing blade collective pitch adjusting device 9 and rotation speed difference of the upper and lower rotor-wings, so that the extra torque compensation and lateral moment control are eliminated, and the length of the entire aircraft and the weight of the system are reduced. Due to small vertical projection area of the lifting fuselage 3, and integrated with the technical characteristics of the above components, the aerodynamic efficiency of the aircraft in hover may be effectively improved. During low-speed flight, the forward flying propulsion device 5 provides most of forward flight thrust, forming a coaxial dual rotor-wing tail-pushing layout; in the flight status, the total power requirement for level flight is relatively lowest in the entire flight envelope, which may provide maximum endurance for the aircraft.

The overall layout of fixed wing configuration of the aircraft is shown in FIG. 3. The lifting fuselage 3 is in horizontal state along downstream flow, dual groups of dual blade variable rotor-wings 1 are symmetrically distributed at the left and right ends of the lifting fuselage 3, the forward and backward swept wing blades 11 are adjusted through a variable sweep angle device 8 at a rotor hub 12, thus forming a front-rear tandem rotor-wing layout, and generating lift together with the lifting fuselage 3. The overall configuration of the aircraft is similar to a flying wing configuration with small aspect ratio, and has relatively high performance parameters such as lift to drag ratio, range, speed and altitude, meanwhile, the direct force control on pitching, rolling and partial yawing of the entire aircraft is realized by changing the collective pitch of each wing blade 11 in a coordinated mode, so as to improve the maneuverability and control efficiency.

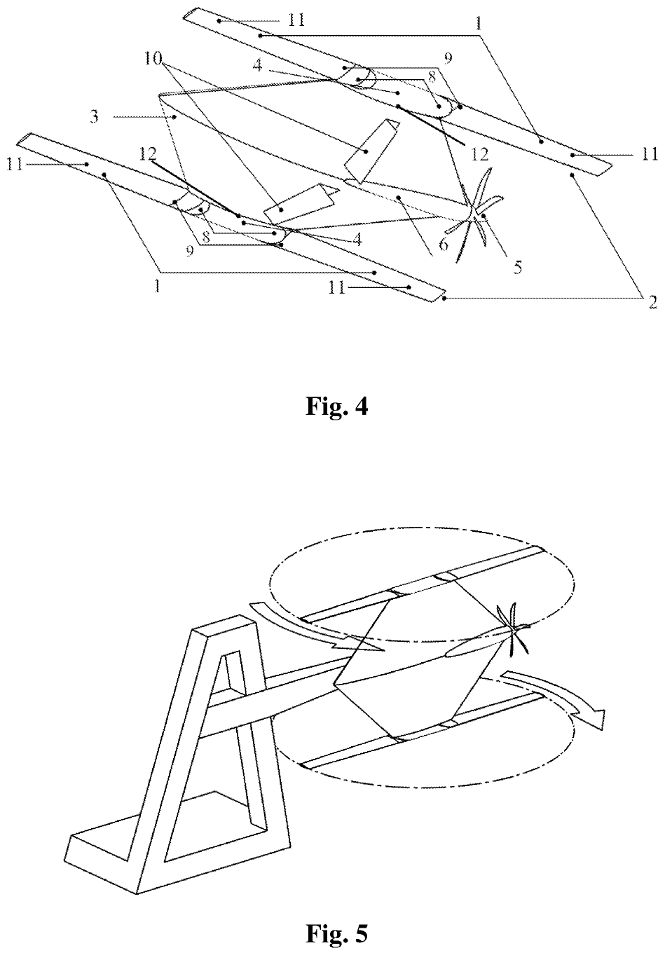

The typical shape of the aircraft in the transition flight state is shown in FIG. 4, the lifting fuselage 3 remains in a horizontal state along downstream flow for most of the time, and the fuselage spoiler 10 on the lower surface continues to deflect to increase lift, which together generate all lift required by stable level flight of the aircraft. The dual groups of dual blade variable rotor-wings 1 complete transition between the two configurations including high-speed rotation and static sate of spanwise along the airflow in the rotor disk planes which are vertically placed along the airflow, and the total aerodynamic force of the components is completely unloaded by adjusting the collective pitch of each wing blade 11, which effectively reduces the influence on the attitude of the aircraft. When the dual blade variable rotor-wings 1 enter the high-speed rotation state, the lifting fuselage 3 may switch from the horizontal state along downstream flow to vertical state along downstream flow by laterally rolling 90 degrees, the rotor disk planes of the dual blade variable rotor-wings 1 returns to the horizontal state and the collective pitch is adjusted to generate lift, and the entire aircraft enters the rotor wing configuration smoothly; when the dual blade variable rotor-wings 1 enter the static state of spanwise along airflow, the wing surfaces of the dual blade variable rotor-wings 1 are rotated to horizontal by the wing-fuselage connecting mechanism 4, then forward and backward swept angles of each wing blade 11 are adjusted through the variable sweep angle device 8, and finally, the fixed wing configuration is formed.

The aircraft uses the vertical take-off and landing by depending the rotor-wing concept; compared with most existing vertical take-off and landing aircrafts, the power demand on the central power system 6 is reduced, and meanwhile, through a coaxial dual rotor-wing tail-pushing layout, better performance, efficiency and maneuverability are obtained in hover and low-speed forward flight. When medium-high speed is reached, the aircraft will enter the fixed wing configuration, and the level flight efficiency and better maneuverability similar to that of the existing fixed-wing aircraft are obtained through the front-rear tandem rotor-wing layout and lifting fuselage. In the transition flight state, the flight attitude of the entire aircraft is less interfered, and the lift generated by the lifting fuselage 3 is stable and controllable, which effectively reduces the risk and difficulty of the flight process.

The following will illustrate the basic flight procedures of the aircraft with the attached drawings by taking a complete flight process as an example.

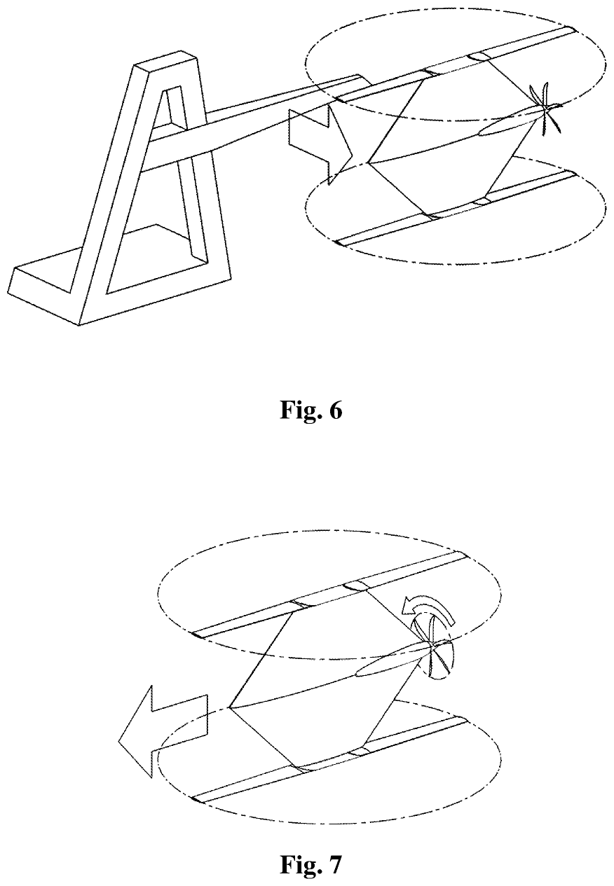

At the beginning of take-off, the aircraft is hung on the take-off and landing auxiliary device 7 in a rotor wing configuration, in such a case, the lifting fuselage 3 is placed vertically, and the take-off and landing device 7 is connected to the belly portion of the lifting fuselage 3, as shown in FIG. 5; the main power device 4 is gradually loaded till full-load operation, during this process, the direct transmission to the forward flying propulsion device 5 is temporarily cut off, and all the power is outputted to the dual groups of dual blade variable rotor-wings 1, and the latter is driven to accelerate rotation along the curved arrow direction in FIG. 5; when the rotating speed of the dual blade variable rotor-wings 1 reaches the lift sufficient to overcome the weight of the aircraft, the lifting fuselage 3 is disconnected from the take-off and landing auxiliary device 7, and the collective pitch and rotation speed of the dual blade variable rotor-wings 1 are adjusted to enable the aircraft to slowly move away from the take-off and landing device 7 in the direction shown by the straight arrow in FIG. 6, and necessary altitude variations and maneuvers are carried out to complete the take-off.

When the aircraft determines that there is no collision danger in the surrounding airspace, the main power device 4 directly drive the forward flying propulsion device 5, and the latter starts to generate thrust to accelerate the entire aircraft forward, as shown in FIG. 7, the curved arrow represents the rotation direction of the forward flying propulsion device 5 in the form of propeller, and the straight arrow represents the forward moving direction of the aircraft. The dual blade variable rotor-wings 1 continues to generate most of lift in the rotor wing configuration, and power requirement will rapidly decrease under the increase speed of the incoming airflow; in such a case, because the power requirement of the forward flying propulsion device 5 increases slowly, the total power requirement of the entire aircraft is in a decreasing trend.

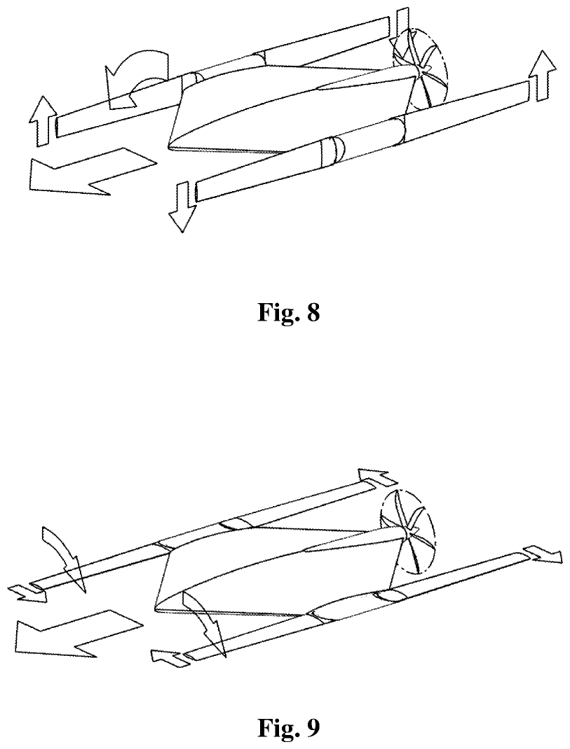

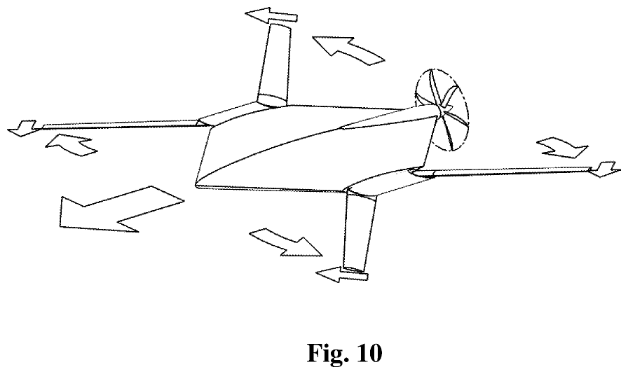

The aircraft needs to enter a transition flight state to complete configuration switching when needing to reach a higher flight altitude and speed. After the flight speed reaches a certain value, the entire aircraft is enabled to roll by 90 degrees laterally along the curved arrow direction in FIG. 8 by differentially changing the collective pitch and rotation speed of the dual blade variable rotor-wing 1 and deflecting the fuselage spoiler 10, the lifting fuselage 3 is placed horizontally along downstream flow, through the relative angle of attack according to the incoming airflow and the lifting effect of the deflecting fuselage spoiler 10, the lift maintaining the level flight of the entire aircraft is generated. The dual blade variable rotor-wing 1 gradually stops rotating in a state that the rotor disk planes of the rotor-wings are vertical state along downstream flow and completely unloaded, until the spanwise direction is approximately parallel to the forward airflow; then the wing-fuselage connecting mechanism 4 turns the dual blade variable rotor-wing1 laterally by 90 degrees along the direction of the curved arrows in FIG. 9, and then adjusts the relative positions of each wing blade 11 along the direction of the curved arrows in FIG. 10 through the variable sweep angle device 8 of each wing blade 11, and finally, the fixed wing configuration is formed. Small straight arrows at the tip of each wing blade 11 in FIGS. 8-10 indicate its leading edge direction.

When the aircraft returns to the take-off and landing auxiliary device 7 or flies to other devices at different positions after completing the task, a series of deceleration, transition and landing operations will be carried out, which are the reverse processes of the above steps, and will not be described again.

What is claimed is:

1. A vertical take-off and landing aircraft based on variable rotor-wing technology and dual rotor-wing layout, comprising dual blade variable rotor-wings, a dual rotor-wing system, a lifting fuselage, a wing-fuselage connecting mechanism, a forward flying propulsion device, a central power system, and a take-off and landing auxiliary device; wherein
the aircraft uses a design of variable configuration to achieve vertical take-off and landing and high-speed level flight, simultaneously;
a main aerodynamic wing surface adopts a design of dual blade variable rotor-wing, which is a core component for the aircraft to generate lift and switch configurations, and can be switched between a rotor wing configuration and a fixed wing configuration with variation of a forward flight speed, and aerodynamic efficiency in entire flight envelope is greatly improved by introducing the dual blade variable rotor-wing technology and the dual rotor-wing layout;
aerodynamic shape of the lifting fuselage and the wing-fuselage connecting mechanism are in coordinated linkage with the rotor-wing configuration, which may maintain stable level flight of the aircraft when the configurations is switching, and risk and difficulty in the switching process are reduced; the aircraft uses a propulsion device at a rear portion to provide forward thrust, and a central power system provide energy for the forward flying propulsion device and the dual rotor-wing system, which improves overall efficiency of the entire aircraft.

2. The vertical take-off and landing aircraft based on variable rotor-wing technology and dual rotor-wing layout according to claim 1, wherein
working state of the main aerodynamic wing surface can be divided into a rotor wing configuration and a fixed wing configuration, and a transition flight state connecting the rotor wing configuration and the fixed wing configuration;
a flight speed of the rotor wing configuration is low, and the main aerodynamic wing surface generate all lift by rapidly rotating around its vertical central axes; the fixed wing configuration corresponds to medium-high speed flight, and the main aerodynamic wing surface are rigidly connected with the lifting fuselage and generate all lift together with the lifting fuselage;
a speed range of the transition flight state is between that of the rotor wing configuration and the fixed wing configuration; the lifting fuselage generates all lift, and the main aerodynamic wing surface maintain aerodynamic force unloading in entire process.

3. The vertical take-off and landing aircraft based on variable rotor-wing technology and dual rotor-wing layout according to claim 1, wherein
the main aerodynamic wing surface adopts dual blade variable rotor-wing design, and can be switched between the rotor wing configuration and the fixed wing configuration with the variation of the forward flight speed of the aircraft;
on basis of the dual blade rotor-wing, a variable sweep angle device capable of independently adjusting sweep angle is provided at a connection between each wing blade and a rotor hub, and a dual blade variable rotor-wing is formed; a leading-trailing ends asymmetric wing section shape is adopted, and a wing blade collective pitch adjusting device is arranged on an outer side of a variable sweep angle device of each of the dual blade variable rotor-wing;
when the main aerodynamic wing surface is switched to the rotor wing configuration, each group of the dual blade variable rotor-wing carries out cyclic pitch variation through a teetering of the rotor hub.

4. The vertical take-off and landing aircraft based on variable rotor-wing technology and dual rotor-wing layout according to claim 1, wherein
the design of a dual rotor-wing system is adopted, and two sets of the dual blade variable rotor-wing which are independent and operate in a coordinated mode are arranged in parallel on the lifting fuselage by adopting a mirror symmetry mode.

5. The vertical take-off and landing aircraft based on variable rotor-wing technology and dual rotor-wing layout according to claim 1, wherein
a shape of the lifting fuselage is similar to a flying wing with small aspect ratio, two sets of fuselage spoiler are lateral-symmetrically arranged on a lower surface; the lifting fuselage can laterally roll by 90 degrees around a speed direction of the aircraft in the transition flight state.

6. The vertical take-off and landing aircraft based on variable rotor-wing technology and dual rotor-wing layout according to claim 1, wherein
the wing-fuselage connecting mechanism is arranged at two spanwise ends of the lifting fuselage for connecting the lifting fuselage and the dual blade variable rotor-wing, and a 90-degree rotating shaft and corresponding actuating device are provided with a rotating direction opposite to a lifting fuselage rolling direction.

7. The vertical take-off and landing aircraft based on variable rotor-wing technology and dual rotor-wing layout according to claim 1, wherein
the forward flying propulsion device is mounted at the rear portion of the lifting fuselage to provide forward flying thrust for the aircraft, and it can be selected from two ways comprising propeller or jet.

8. The vertical take-off and landing aircraft based on variable rotor-wing technology and dual rotor-wing layout according to claim 1, wherein
the central power system provides power for the dual rotor-wing system and the forward flying propulsion device, and is composed of a main power device and a transmission device;
the main power device generates most of energy for the aircraft, and can be selected from the internal combustion engine, battery, or gas turbine; the transmission device distributes energy to the dual rotor-wing system and the forward flying propulsion device according to flight state via mechanical transmission, electric transmission or bleed air.

9. The vertical take-off and landing aircraft based on variable rotor-wing technology and dual rotor-wing layout according to claim 1, wherein
the take-off and landing auxiliary device is rigidly connected with a mechanism device in a belly portion of the lifting fuselage through an extended mechanical arm to support the aircraft in the apron parking status.

10. The vertical take-off and landing aircraft based on variable rotor-wing technology and dual rotor-wing layout according to claim 2, wherein
when the aircraft is in the rotor wing configuration, the lifting fuselage is in a vertical state along downstream flow, rotor disk planes of the two sets of dual blade variable rotor-wing are kept horizontal but the rotation directions are opposite, a rotating shaft is mutually overlapped and pass through a centre of gravity of the entire aircraft, thus forming a coaxial dual rotor-wing tail-pushing layout with the forward flying propulsion device.

11. The vertical take-off and landing aircraft based on variable rotor-wing technology and dual rotor-wing layout according to claim 2, wherein
when the aircraft is in the fixed wing configuration, the lifting fuselage is in a horizontal state along downstream flow, two sets of dual blade variable rotor-wing are located on a left end and a right end of the lifting fuselage and are in mirror symmetry relative to the central symmetry plane of the lifting fuselage, wing blades of each set of the dual blade variable rotor-wing are kept horizontal and in front-rear tandem arrangement, and forms a front-rear tandem rotor-wing layout with the lifting fuselage.

12. The vertical take-off and landing aircraft based on variable rotor-wing technology and dual rotor-wing layout according to claim 2, wherein
when the aircraft is in the transition flight state, the dual blade variable rotor-wings are in coordinated linkage with the lifting fuselage through the wing-fuselage connecting mechanism;
wherein the lifting fuselage can laterally roll by 90 degrees around a speed direction of the aircraft, and switch between the horizontal state along downstream flow and the vertical state along downstream flow, and maintain in the horizontal state along downstream flow for most of the time to generate all lift required by level flight; the dual blade variable rotor-wing rapidly switch the rotor-wing configuration in a mode of completely unloading aerodynamic force under assistance of the wing-fuselage connecting mechanism.
